(19) United States
(12) Patent Application Publication
(10) Pub. No.: US 2015/0045094 A1
(43) Pub. Date: Feb. 12, 2015

(54) COLOR CONVERSION KIT FOR MOBILE ELECTRONIC DEVICES

(71) Applicant: Invisible Device Armor, LLC, Draper, UT (US)

(72) Inventors: Mark Andrew Patterson, Herriman, UT (US); Gregory Blair Norris, Sandy, UT (US)

(21) Appl. No.: 13/962,802

(22) Filed: Aug. 8, 2013

(51) Int. Cl. H04B 1/38

(52) U.S. Cl. CPC H04B 1/3888
USPC 455/566

(57) ABSTRACT

A color-conversion kit for a mobile electronic device, such as a mobile phone, comprises a front member, a back member, a side strip member, and a bumper member. The front member is adhered to the display side of the mobile electronic device while the back member is adhered to the back of the mobile electronic device. The side strip member is adhered to the sides of the mobile electronic device. The bumper member is applied to the sides of the electronic device over the side strip member. A transparent portion of the bumper member allows viewing of the side strip member even though covered by the bumper member.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Present Disclosure

The present disclosure relates generally to mobile electronic devices, and more particularly, but not necessarily entirely, to accessories for changing the appearance of mobile electronic devices.

2. Description of Related Art

With the proliferation of mobile electronic devices, accessories for the devices have also risen in popularity. Perhaps the most popular accessories for mobile electronic devices include screen protectors and protective cases. The purpose of the screen protectors is primarily to protect the displays of the devices from scratches. In this regard, screen protectors may comprise a thin sheet of transparent material. The primary purpose of the protective cases is to protect the devices from damage caused by impacts.

Manufacturers typically offer mobile electronic devices in limited color schemes. For example, the popular iPhone, manufactured by Apple Inc., is available in only two color schemes, black and white. Often times, users desire the ability to change the factory color scheme of their electronic devices. While protective cases may provide the ability to change a color of an electronic device, protective cases typically fail to provide a suitable full-color conversion of the electronic device. Some accessories are adapted to replace the original housing of a mobile phone. However, this approach is disfavored since it may void the manufacturer's warranty.

Thus, despite the advantages of known mobile electronic device accessories, improvements are still being sought. For example, there exists a need for a cost-effective, full-color conversion kit for mobile electronic devices. The prior art is thus characterized by several disadvantages that are addressed by the present disclosure. The present disclosure minimizes, and in some aspects eliminates, the above-mentioned failures, and other problems, by utilizing the methods and structural features described herein.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 depicts the components of a color-conversion kit according to an embodiment of the present disclosure;

FIG. 2 depicts applying a front member to a mobile phone according to an embodiment of the present disclosure;

FIG. 3 depicts applying a back member to the mobile phone depicted in FIG. 2 according to an embodiment of the present disclosure;

FIG. 4 depicts applying a side strip member to the mobile phone depicted in FIG. 2 according to an embodiment of the present disclosure;

FIG. 5 depicts applying a bumper member to the mobile phone depicted in FIG. 2 according to an embodiment of the present disclosure; and

FIG. 6 depicts a color-conversion kit installed on the mobile phone depicted in FIG. 2.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. It must be noted that, as used in this specification and the appended claims, the singular forms “a,” “an,” and “the” include plural referents unless the context clearly dictates otherwise. As used herein, the terms “comprising,” “including,” “containing,” “having,” “characterized by,” and grammatical equivalents thereof are inclusive or open-ended terms that do not exclude additional, unrecited elements or method steps.

Applicant has discovered a full-color conversion kit for use with mobile electronic devices. As used herein, the term “mobile electronic device” refers to mobile phones and electronic music players, tablets, and other hand-held mobile electronic devices. Examples of mobile phones include iPhones manufactured by Apple Inc. and the Galaxy S phones manufactured by Samsung Electronics Co., Ltd. Applicant's full-color conversion kit may be modular and may comprise a front piece, a rear piece, a side strip piece, and a bumper piece. When installed, the Applicant's kit provides a full-color conversion kit for a mobile electronic device.

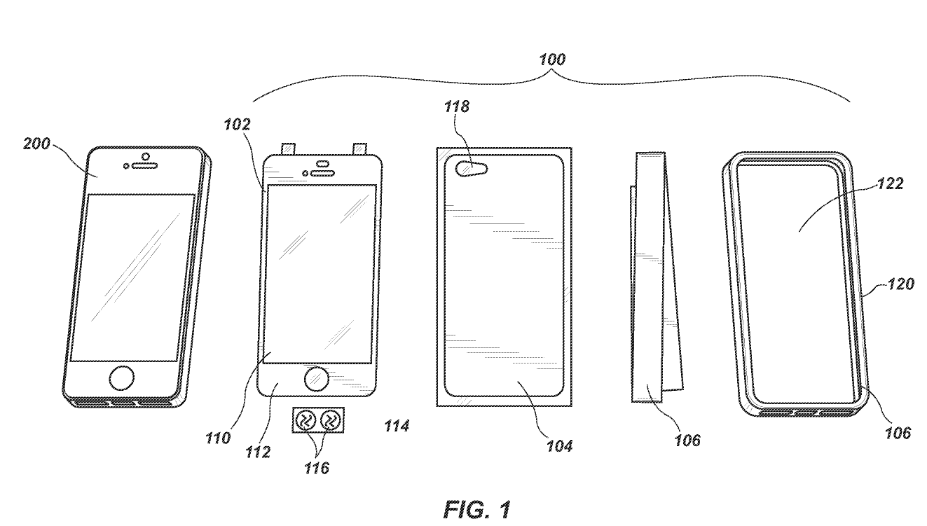

Referring now to FIG. 1, there is depicted the components of a full-color conversion kit 100 for a mobile electronic device 200 according to an embodiment of the present disclosure. The kit 100 may comprise a front member 102, a back member 104, a side strip member 106, and a bumper member 108. In an embodiment, the front member 102 may be formed of a rigid material, such as glass or plastic. The front member 102 may include a transparent portion 110. The transparent portion 110 may be configured and dimensioned to correspond in size to a display portion on the electronic device 200. The front member 102 may further include an opaque portion 112. The opaque portion 112 may extend along the borders of the transparent portion 110. In an embodiment, the opaque portion 112 may have a desired color.

The opaque portion 112 of the front member 102 may further comprise a plurality of openings 114. The openings 114 may allow access to any control buttons of the device 200. The openings 114 may also ensure that any microphones, speakers, lenses of the device 200 remain unobstructed. The kit 100 may further comprise button covers 116 that are configured and dimensioned to fit over any control buttons of the device 200.

A rear surface of the front member 102 may include an adhesive layer for securing it to the front of the device 200. The adhesive layer may be covered with a thin plastic sheet that is removed just prior to installation. The dimensions of the front member 102 may correspond to the dimensions of the front surface of the device 200. In an embodiment, a thickness of the front member 102 may be about 1 millimeter. In an embodiment, the thickness of the front member 102 may be less than 1 millimeter. In an embodiment, the thickness of the front member 102 may be more than 1 millimeter. In an embodiment, the front member 102 may have a width of about 5 to 6 millimeters and a height of about 11 to 13 millimeters.

The back member 104 may be comprised of a flexible and resilient material. A surface of the back member 104 may include an adhesive layer to secure the back member 104 to a backside of the device 200. The adhesive layer may be covered with a material, such as wax paper, that is removed just prior to installation. The back member 104 may include a cutout 118 for a camera lens or speakers of the device 200. In an embodiment, the back member 104 may have a desired color.

The side strip member 106 may be comprised of a flexible and resilient material. A surface of the side strip member 106 may include an adhesive layer to secure the side strip member 106 to a side of the device 200. The adhesive layer may be covered with a material, such as wax paper, that is removed just prior to installation. The side strip member 106 may include cutouts for buttons, speakers, and plugs extending from, or located in, the side of the device 200. In an embodiment, the side strip member 106 may have a desired color.

The bumper member 106 may include a wall 120 that defines a space 122 for receiving the mobile electronic device 200. The wall 120 may be constructed of a resilient material in order to provide protective cushioning. The wall 120 may include openings for allowing user access to buttons, speakers, ports, and plugs extending from the sides of the device 200. The openings in the wall 120 may also provide access to plugs and ports of the electronic device 200. In addition, the wall 120 may include its own buttons that overlay buttons extending from the sides of the device 200.

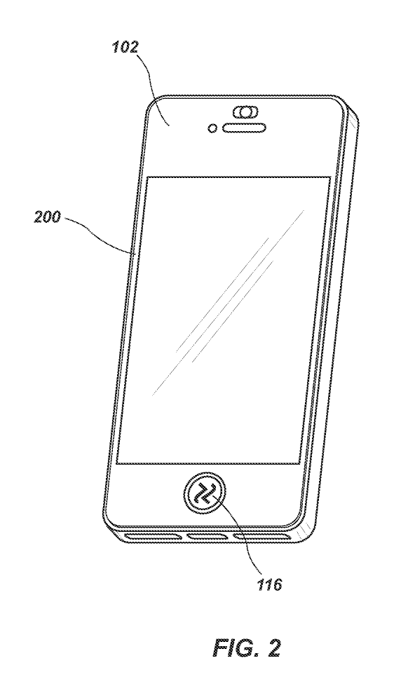

Referring now to FIGS. 2-6, the method of installing the kit 100 onto the electronic device 200 are shown according to an embodiment of the present disclosure. It will be appreciated that the order of the method shown in FIGS. 2-6 may be varied. That is, it will be appreciated that the installation of the kit 200 need not be performed according to the order shown in FIGS. 2-6, and that the scope of the present invention is sufficiently broad to cover the components of the kit 200 being installed onto the electronic device 200 in any order.

First, as shown in FIG. 2, the front member 102 of the kit 100 is installed onto the front or display side of the electronic device 200. In particular, the button cover 116 may be installed into the button on the front of the device 200. The front member 102 may then be installed by removing the plastic sheet over the adhesive layer on the underside of the front member 102. The front member 102 is then aligned over the front of the electronic device 200 and then firmly pressed against the front of the electronic device 200 such that the adhesive layer joins the front member 102 and the electronic device 200 together.

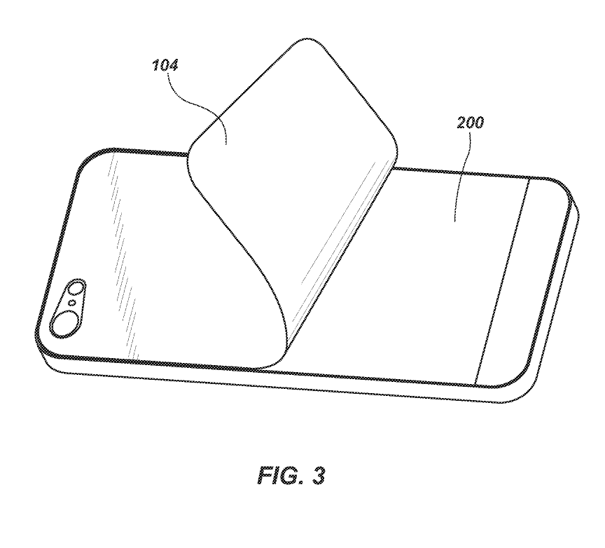

Second, as shown in FIG. 3, the back member 104 is then installed onto the back of the electronic device 200. In particular, the protective wax paper covering the adhesive layer is removed. The back member 104 is then aligned and pressed firmly, and optionally heated, onto the back of the electronic device 200, taking care that the openings in the back member 104 are properly aligned with the parts of the electronic device 200 that need to remain uncovered, e.g., the camera lens should not be covered.

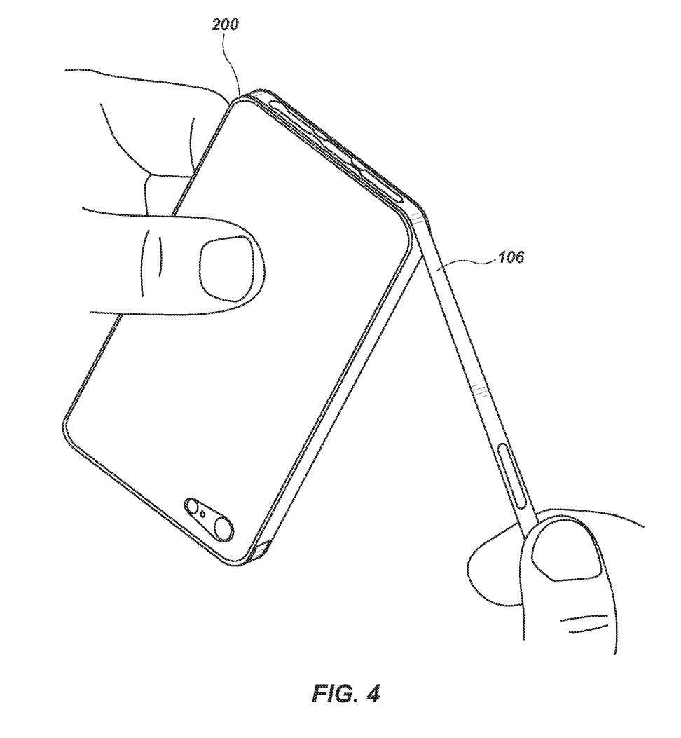

Third, as shown in FIG. 4, the side strip member 106 is then installed onto the sides of the electronic device 200. In particular, the protective wax paper covering the adhesive layer is removed. The side strip member 106 is then aligned and pressed firmly onto the sides of the electronic device 200, taking care that the openings in the side strip member 106 are properly aligned with the parts of the electronic device 200 that need to remain uncovered, e.g., any buttons, plugs and ports extending from the sides of the electronic device 200 should remain uncovered.

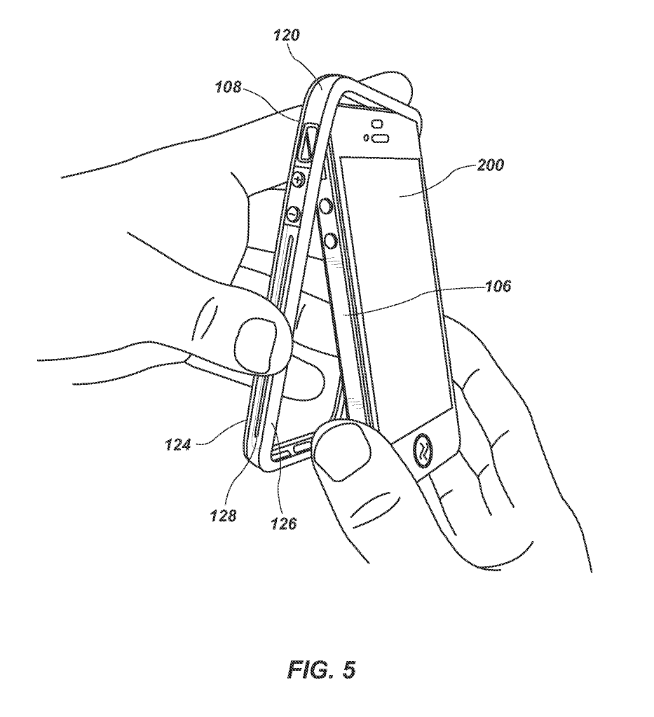

Last, as shown in FIG. 5, the bumper member 108 is installed onto the sides of the electronic device 200 over the side strip member 106. In this regard, the wall 120 of the bumper member 108 may include a pair of spaced apart opaque portions 124 and 126. Interposed between the opaque portions 124 and 126 may be a transparent portion 128. The transparent portion 128 may allow the side strip portion 106 to be viewed through the bumper member 108. In an embodiment, the transparent portion 128 is absent from the bumper member 108. The bumper member 108 may slightly deform in order to snugly fit onto the electronic device 200. That is, the resilient nature of the bumper member 108 may secure it to the electronic device 200.

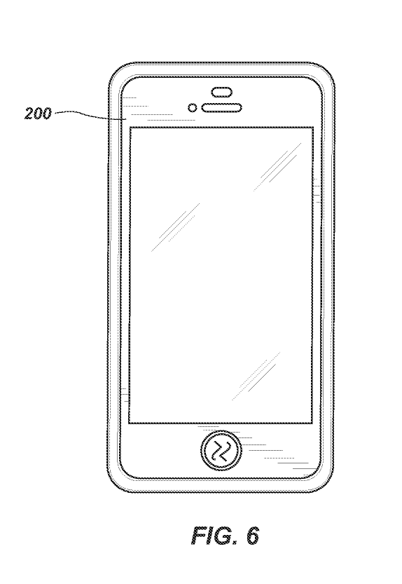

FIG. 6 shows the components of the kit 100 fully installed onto the electronic device. It will be appreciated that the components of the kit 100, namely, the front member 102, the back member 104, the side strip member 106, and the bumper member 108 (except for the transparent portion 128) may comprise a color. In an embodiment, each of the components of the kit 100 may comprise the same color. In an embodiment, one or more components comprise a different color or multiple covers. In an embodiment, the components of the kit 100 comprise a pleasing design.

In an embodiment, the kit 100 may include a wipe in a sealed packaged that may be utilized for cleaning the display of the electronic device. In an embodiment, the wipe is an alcohol wipe or a wet wipe.

It will be appreciated that the structure and apparatus disclosed herein is merely one example of a means for converting a color of a mobile electronic device, and it should be appreciated that any structure, apparatus or system for converting a color of a mobile electronic device which performs functions the same as, or equivalent to, those disclosed herein are intended to fall within the scope of a means for converting a color of a mobile electronic device, including those structures, apparatus or systems for converting a color of a mobile electronic device which are presently known, or which may become available in the future. Anything which functions the same as, or equivalently to, a means for converting a color of a mobile electronic device falls within the scope of this element.

In accordance with the features and combinations described above, a useful method of converting a color of a mobile electronic device includes the steps of:

(a) installing a front member onto the display side of the electronic device;

(b) installing a back member onto the backside of the electronic device;

(c) installing a side strip member onto the sides of the electronic device; and

(d) installing a bumper member onto the sides of the electronic device.

Those having ordinary skill in the relevant art will appreciate the advantages provided by the features of the present disclosure. For example, it is a feature of the present disclosure to provide a color conversion kit on an electronic device. Another feature of the present disclosure to provide such a color conversion kit having a protective bumper member. It is a further feature of the present disclosure, in accordance with one aspect thereof, to provide a kit for mobile phones.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A color conversion kit for a mobile electronic device having a display side, a backside, and sides, the kit comprising:
a front member having a transparent portion, the front member configured and dimensioned to cover the display side of the mobile electronic device;
a back member, the back member configured and dimensioned to cover the backside of the mobile electronic device, the backside being opposite the display side of the mobile electronic device;
a side strip member configured and dimensioned to cover sides of the mobile electronic device; and
a bumper member configured and dimensioned to be installed onto the sides of the mobile electronic device over the side strip member.

2. The color conversion kit of claim 1, wherein the front member comprises glass.

3. The color conversion kit of claim 2, wherein the front member comprises plastic.

4. The color conversion kit of claim 1, wherein the front member further comprises an opaque portion.

5. The color conversion kit of claim 4, wherein the opaque portion bounds a perimeter of the transparent portion.

6. The color conversion kit of claim 1, wherein the front member comprises one or more openings corresponding to buttons or speakers on the display side of the mobile electronic device.

7. The color conversion kit of claim 1, wherein the back member comprises one or more openings corresponding in position to a camera lens on the backside of the mobile electronic device.

8. The color conversion kit of claim 1, wherein the side strip member one or more openings corresponding to buttons, plugs or ports on sides of the mobile electronic device.

9. The color conversion kit of claim 1, wherein the bumper member comprises a wall, wherein the wall comprises a transparent portion.

10. The color conversion kit of claim 9, wherein the transparent portion is bounded on either side by a resilient opaque portion.

11. A method of converting a color of a mobile electronic device having a display side, a backside, and sides, said method comprising:
(a) installing a front member onto the display side of the electronic device, the front member having a transparent portion;
(b) installing a back member onto the backside of the electronic device;
(c) installing a side strip member onto sides of the electronic device; and
(d) installing a bumper member onto the sides of the electronic device over the side strip member.

12. The method of claim 11, wherein the front member comprises glass.

13. The method of claim 12, wherein the front member further comprises plastic.

14. The method of claim 11, wherein the front member further comprises an opaque portion.

15. The method of claim 14, wherein the opaque portion bounds a perimeter of the transparent portion.

16. The method of claim 11, wherein the front member comprises one or more openings corresponding to buttons or speakers on the display side of the mobile electronic device.

17. The method of claim 11, wherein the back member comprises one or more openings corresponding in position to a camera lens on the backside of the mobile electronic device.

18. The method of claim 11, wherein the side strip member one or more openings corresponding to buttons, plugs or ports on the sides of the mobile electronic device.

19. The method of claim 11, wherein the bumper member comprises a wall, wherein the wall comprises a transparent portion.

20. The method of claim 11, wherein the transparent portion is bounded on either side by a resilient opaque portion.
